(19) United States
(12) Patent Application Publication
(10) Pub. No.: US 2017/0148120 A1
(43) Pub. Date: May 25, 2017

(54) Method for Licensing a Copyrighted Work over a Network

(71) Applicant: Tsung-Yu Chen, Tainan City (TW)

(72) Inventor: Tsung-Yu Chen, Tainan City (TW)

(21) Appl. No.: 15/186,607

(22) Filed: Jun. 20, 2016

(30) Foreign Application Priority Data
Nov. 20, 2015 (TW) 104138643

(51) Int. Cl. G06Q 50/18; G06Q 30/06

(52) U.S. Cl. CPC G06Q 50/184; G06Q 30/0601; G06Q 30/0645

(57) ABSTRACT

A method for licensing a copyrighted work over a network includes a login step in which a copyright owner logs in a first network copyright license system. In a copyright registration step, the copyright owner uploads registration information of a copyrighted work to the first network license system. In a renting/selling setting step, a person obtains the copyrighted work information, finishes a renting/selling agreement with the copyright owner through a second network copyright license system, and becomes a licensee. In a network renting/selling step, a consumer browses a network renting/selling system of the second network copyright license system and selects the copyrighted work to be read. The second network renting/selling system electrically transfers a portion of the renting/selling fee to the copyright owner according to the distribution ratio of the income from renting/selling the copyrighted work set in the renting/selling license setting step.

### BACKGROUND OF THE INVENTION

The present invention relates to a method for licensing a copyrighted work over a network and, more particularly, to a method permitting a copyright owner to proceed with setting of a copyrighted work over a network and to proceed with transregional license of renting and selling of the copyrighted work.

Electronic copyrighted works, such as electronic books, films, and comics, spread over networks have become more popular. Consumption over networks have become international, which is promising to copyrighted works. Currently, a copyrighted work, particularly a book or audio/video information, has to be translated by a licensee into another language before circulation in a region using such language. However, the copyright owner, particularly a small-business-scale independent copyright owner, cannot obtain the exact condition of sales of the copyrighted work in the region using the translated language, such that the copyright owner cannot obtain the reasonable profit. Namely, the economic interest of the copyright owner is damaged in the transregional license. Furthermore, the copyright owner cannot proceed with open license or publication of the copyrighted work, which is a loss to the consumers.

Different countries have different copyright laws. Some countries adopt legal registration system, but more countries require the copyright owner to provide the evidence of the completion date of the work. Registration or claim of the copyright of the work is a burden in expenses and time to a small-business-scale owner seeking international or interregional license. Considerable time and money are required for obtaining the international proof of the completion date of the work, and the legalization is more troublesome. Thus, it is complicated and difficult to legally prove the source of the same work, not to mention claiming or licensing the copyright in foreign countries. As a result, there are more and more damages to copyrighted works in other countries or regions using different languages.

As for renting a copyrighted work, currently available techniques include using a network renting/selling license system to provide login through identity identification. After online payment on a renting/selling web page, a user can read the copyrighted work during a predetermined period of time which may range from three days to several months. When the predetermined period of time expires, the network renting/selling license system terminates the authority to read the copyrighted work through a computer or a hand-held smart device.

To assure the consumer has sufficient time to read, the network renting/selling license system often sets an ample time period longer than the normal time period required by the consumer. Taking a movie as an example, the network renting/selling license system often sets 3-5 days to permit the consumer to watch a 2-hour film. The time period may be up to a month in the case of an electronic book to avoid damage to the right of the consumer.

However, such a network renting/selling license mode is advantageous to consumers having a low reading speed. Consumers having a high reading speed are often limited by the set time period and let the set time period lapse after having read the copyrighted work long before the deadline. The fixed time period is not suitable to efficient consumers and is, thus, not a renting/selling mode fulfilling the demands of consumers. However, current network renting/selling license systems do not have a good solution to this problem, nor can they change the renting/selling time condition. Thus, current network renting/selling license modes are defective in use.

### BRIEF SUMMARY OF THE INVENTION

A method for licensing a copyrighted work over a network according to the present invention includes:

A Login Step: a copyright owner of a work logs in a first network copyright license system and enters information of the copyright owner into the first network copyright license system;

A Copyright Registration Step: the copyright owner uploads copyright registration information to the first network copyright license system, wherein the copyright registration information includes an identity of the copyright owner of the work, an identity of an author of the work, a completion date of the work, a type of the work, originally registered data of the work, a license approach, and license fee;

A Renting/Selling License Setting Step: a person obtains the copyright registration information uploaded by the copyright owner from the first network copyright license system, completes a renting/selling license agreement with the copyright owner through a second network copyright license system, and becomes a licensee, wherein the renting/selling license agreement includes setting of a distribution ratio of an income from renting/selling the copyrighted work, distribution information of the copyrighted work, renting/selling fee of the copyrighted work, and a time period of renting/selling the copyrighted work, and wherein the distribution ratio of the income from renting/selling the copyrighted work includes a distribution ratio of the income from renting/selling the copyrighted work between the second network copyright license system, the licensee, and the copyright owner;

A Network Renting/Selling Step: the copyrighted work is published on a second network renting/selling system of the second network copyright license system after the renting/selling license setting step, a consumer browses the second network renting/selling system and selects the copyrighted work to be read, wherein after the consumer has paid the renting/selling fee for the copyrighted work, the second network renting/selling system electrically transfers a portion of the renting/selling fee to the copyright owner according to the distribution ratio set in the renting/selling license setting step.

The method can further include an optional network publication step after the copyright registration step. In the network publication step, the copyright owner proceeds with network publication of the copyrighted work through the first network copyright license system that is connected to the second network copyright license system, propagating the registered copyright information in a region covered by the second network copyright license system, such that the registered copyright information uploaded to the first network copyright license system is accessible to persons in the region covered by the second network copyright license system.

The method can further include an authentication step after the copyright registration step. In the authentication step, the copyright owner applies for authentication of the copyrighted work with the first network copyright license system or the second network copyright license system by an authentication system of the first network copyright license system.

The first network copyright license system includes a first network renting/selling system which performs the following steps:

A Renting/Selling Setting Step: the copyright owner proceeds with setting of renting/selling conditions of the copyrighted work, the renting/selling conditions include a distribution ratio of an income from renting/selling the copyrighted work, distribution information of the copyrighted work, renting/selling fee of the copyrighted work, and a time period of renting/selling the copyrighted work, and wherein the distribution ratio of the income from renting/selling the copyrighted work includes a distribution ratio of the income from renting/selling the copyrighted work between the first network copyright license system and the copyright owner;

A Network Renting/Renting Step: the copyrighted work is published on the first network copyright license system, a consumer browses the first network copyright license system and selects the copyrighted work to be read, wherein after the first network copyright license system has received payment from the consumer, the first network copyright license system electrically transfers a portion of the renting/selling fee to the copyright owner according to the distribution ratio set in the renting/selling setting step;

A Sublease Setting Step: the consumer optionally proceeds with sublease setting on a renting/selling web page platform of the first network copyright license system during the time period of renting/selling, the sublease setting includes sublease fee, registration of personal information and bank account information of each subleasee, and a distribution ratio of an income from the sublease of the copyrighted work, wherein a proportional fee distributed to the first network copyright license system by the sublease setting step is distributed to the copyright owner according to the distribution ratio set in the renting/selling setting step, and the renting/selling web page platform of the first network copyright license system publishes the sublease information to another consumers; and

A Network Sublease Step: one of the another consumers selects the copyrighted work to be sublet on the renting/selling web page platform of the first network copyright license system, the first network copyright license system permits the one of the another consumers to unlimitedly read the copyrighted work during the time period of sublease after the one of the another consumers has paid the sublease fee, the income from the sublease is distributed according to the distribution ratio set in the sublease setting step to proceed with a sublease feedback and an extension feedback, wherein the sublease feedback includes distributing the income from the sublease to the consumer in the sublease setting step, and wherein the extension feedback includes distributing the income from the sublease that has been distributed to the first network copyright license system based on the sublease setting in the sublease setting step to the copyright owner according to the distribution ratio set in the renting/selling setting step.

In an example, the second network copyright license system performs the following steps: a sublease setting step: the consumer optionally proceeds with sublease setting on the second network copyright license system during the time period of renting/selling, the sublease setting includes sublease fee, registration of personal information and bank account information of each subleasee, and a distribution ratio of an income from the sublease of the copyrighted work, wherein a proportional fee distributed to the second network copyright license system by the sublease setting step is distributed to the copyright owner according to the distribution ratio set in the renting/selling license setting step, and the second network copyright license system publishes the sublease information to another consumers; and

A Network Sublease Step: one of the another consumers selects the copyrighted work to be sublet on the second network renting/selling system of the second network copyright license system, the second network renting/selling system permits the one of the another consumers to unlimitedly read the copyrighted work during the time period of the sublease after the one of the another consumers has paid the sublease fee, the income from the sublease is distributed according to the distribution ratio set in the sublease setting step to proceed with a sublease feedback and an extension feedback, wherein the sublease feedback includes distributing the income from the sublease to the consumer in the sublease setting step, and wherein the extension feedback includes distributing the income from the sublease that has been distributed to the second network copyright license system based on the sublease setting in the sublease setting step to the copyright owner according to the distribution ratio set in the renting/selling license setting step.

The first network copyright license system can distribute the income from the sublease of the copyrighted work according to the sublease distribution ratio after the sublease setting step is completed.

The first network copyright license system permits the consumer to electrically and unlimitedly read the copyrighted work during the time period of renting/selling after the consumer has paid in the network renting/selling step.

The present invention will become clearer in light of the following detailed description of illustrative embodiments of this invention described in connection with the drawings.

### DESCRIPTION OF THE DRAWINGS

FIG. 1 is a diagrammatic view illustrating primary steps of a system of an example according to the present invention.

FIG. 2 is a diagrammatic view illustrating steps of the system according to the present invention.

FIG. 3 is a diagrammatic view illustrating steps of the system of another example according to the present invention.

FIG. 4 is a diagrammatic view illustrating a sublease procedure of the system according to the present invention.

FIG. 5 is a diagrammatic view illustrating another sublease procedure of the system according to the present invention.

### DETAILED DESCRIPTION OF THE INVENTION

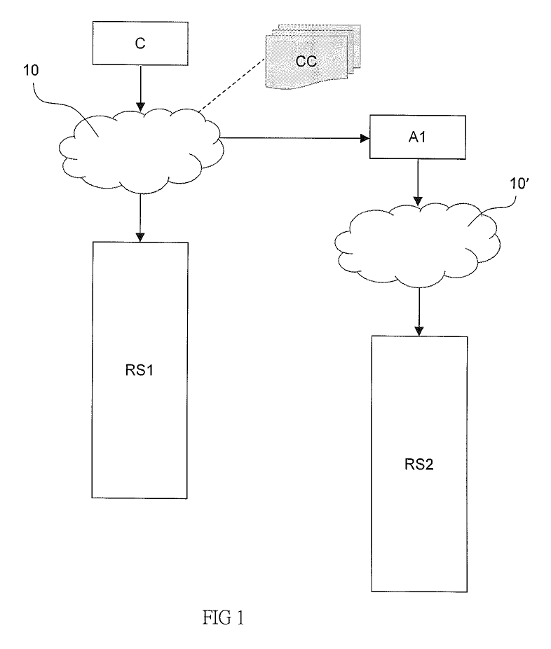

FIG. 1 is a diagrammatic view illustrating primary steps of a system of an example according to the present invention for carrying out a method for licensing a copyrighted work owned by a copyright owner C over a network. To permit easy and effective proceeding of transregional license of the copyrighted work, the present invention allows the copyright owner C to register the copyrighted work through a first network copyright license system 10, and renting and selling of the copyrighted work in a region (management of renting and selling of the copyrighted work in the region has been authorized by the copyright owner C) by a first network selling/renting system RS1 of the first network copyright license system 10 can be conducted after registration. The first network copyright license system 10 further includes an authentication system CC. After registration of the copyrighted work, the first network copyright license system 10 will identify the information of the copyrighted work through substantive verification, and the information of the copyrighted work, if verified to be correct, will be stored in the authentication system CC. If the information of the copyrighted work is verified to be incorrect, the copyright owner C will be notified to proceed with correction. After the copyrighted work information has been registered and stored in the authentication system CC, the authentication system CC can generate copyright certification necessary to the regulations of the region upon request by the copyright owner C. The copyright certification includes the identity and related identity information of the copyright owner C and the author of the work, the completion date of the work, the type of the work, and the originally registered data of the work, which can be cited to confirm the source of the copyright. After publication over the network, the first network copyright license system 10 can be connected to another region covered by a second network copyright license system 10′ to which a licensee A1 is authorized to register, and transregional renting/selling of the copyrighted work can be proceeded through a second network renting/selling system RS2 of the second network copyright license system 10′.

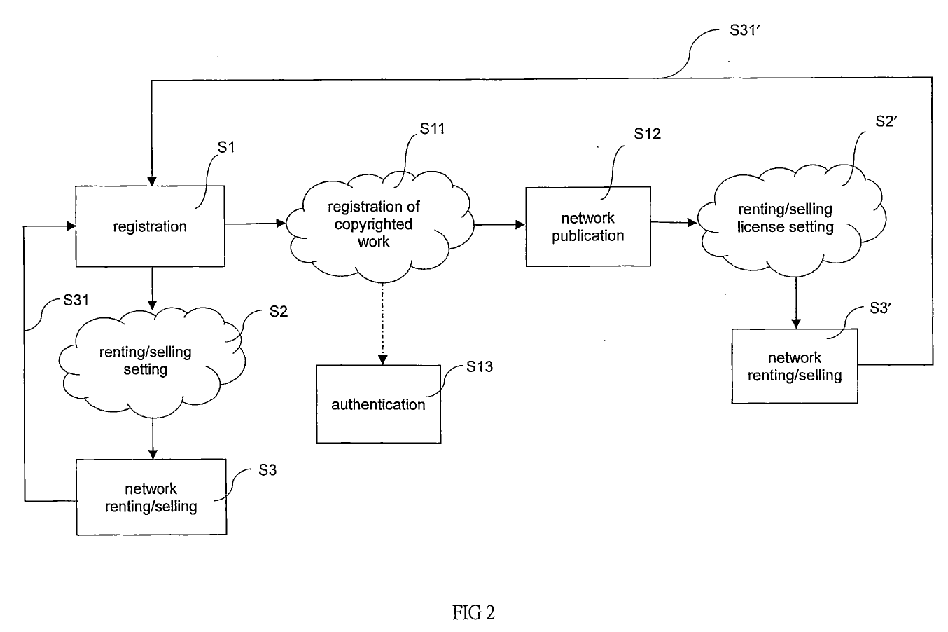

FIG. 2 is a diagrammatic view illustrating steps of the system for carrying out the method according to the present invention. The method includes a login step S1 in which the copyright owner C logs in the first network copyright license system 10 and enters information of the copyright owner C into the first network copyright license system 10. The information of the copyright owner C includes the identity and the bank account information of the copyright owner C.

The method further includes a copyright registration step S11 in which the copyright owner C uploads copyright registration information to the first network copyright license system 10 after the login step S11. The copyright registration information received by the first network copyright license system 10 includes the identity of the copyright owner C of the work, the identity of the author of the work, the completion date of the work, the type of the work, the originally registered data of the work, the license approach, and the license fee. The type of the copyrighted work is classified according to the copyright law of the country (in which the first network copyright license system 10 is located and the renting/selling of the copyrighted work is conducted), such as writing works, figure works, and musical works. After examining the copyrighted work information uploaded to the first network copyright license system 10 by the copyright owner C, the content of the registered information cannot be altered without the consent of the manager of the first network copyright license system 10.

The method further includes an optional network publication step S12 after the copyright registration step S11. In the network publication step S12, the copyright owner C proceeds with publication of the copyrighted work through the first network copyright license system 10 that is connected to the second network copyright license system 10′, propagating the registered copyright information in a region covered by the second network copyright license system 10′, such that the registered copyright information uploaded to the first network copyright license system 10 is accessible to persons in the region covered by the second network copyright license system 10′ through the network.

The method further includes a renting/selling license setting step S2′. When a person in another country or another region obtains the copyright registration information uploaded by the copyright owner C from the first network copyright license system 10 through the network publication step S12 and is intended to obtain the license, this person can have a renting/selling license agreement with the copyright owner C through the second network copyright license system 10′ and becomes a licensee A1. The renting/selling license agreement includes setting of the distribution ratio of the income from renting/selling the copyrighted work, the distribution information of the copyrighted work, the renting/selling fee of the copyrighted work, and the time period of renting/selling the copyrighted work. The distribution ratio of the income from renting/selling the copyrighted work includes the distribution ratio of the income from renting/selling the copyrighted work between the second network copyright license system 10′, the licensee A1, and the copyright owner C. After the renting/selling license agreement has been completed, the income from renting/selling the copyrighted work will be distributed through the second network copyright license system 10′ according to the distribution ratio.

The method further includes a network renting/selling step S3′. The copyrighted work is published on the second network renting/selling system RS2 of the second network copyright license system 10′ after the renting/selling license setting step S2′. A consumer can browse the second network renting/selling system RS2 and can select the copyrighted work to be read. After the consumer has paid the renting/selling fee for the copyrighted work, the second network renting/selling system RS2 electrically transfers a portion of the renting/selling fee (the feedback S31′) to the bank account of the copyright owner C registered in the first network copyright license system 10 in the login step S1 according to the distribution ratio set in the renting/selling license setting step S2′.

The method further includes an authentication step S13 after the copyright registration step S11. In a case that the copyright owner C needs to submit a copyright source certificate, the copyright owner C can apply for authentication of the copyrighted work with the first network copyright license system 10 or the second network copyright license system 10′ by the authentication system CC of the first network copyright license system 10. The first network copyright license system 10 or the second network copyright license system 10′ will provide the copyright owner C with the copyright source certificate according to the copyright law of the country and based on the copyright information uploaded by the copyright owner C in the copyright registration step S11.

By the steps of the method and system according to the present invention, the copyright owner C can easily proceed with license and renting/selling of the copyrighted work in another region through the first network copyright license system 10 or the second network copyright license system 10′. Furthermore, the transregional network renting/selling step S3′ can accurately feedback the income according to the distribution ratio registered in the second network copyright license system 10′, such that the licensee A1 and the copyright owner C can have more accurate interest feedback, making the benefit of the copyrighted work higher and more fair.

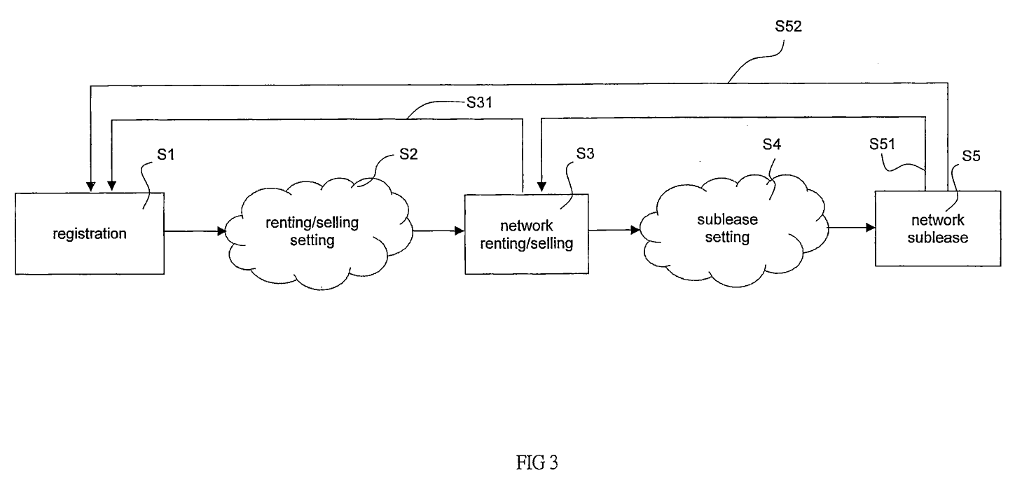

FIG. 3 is a diagrammatic view illustrating steps of the system of another example according to the present invention. In order to achieve the best business interest of the first network copyright license system 10 or the second network copyright license system 10′, the following steps can be carried out in the first network renting/selling system RS1 after the login step S1. Firstly, in a renting/selling setting step S2 after the login step S1, the copyright owner C proceeds with setting of the renting/selling conditions of the copyrighted work. The renting/selling conditions include the distribution ratio of the income from renting/selling the copyrighted work, the distribution information of the copyrighted work, the renting/selling fee of the copyrighted work, and the time period of renting/selling the copyrighted work. The distribution ratio of the income from renting/selling the copyrighted work includes the distribution ratio of the income from renting/selling the copyrighted work between the first network copyright license system 10 and the copyright owner C. After the renting/selling setting, the income from renting/selling the copyrighted work can be distributed through the first network copyright license system 10.

Then, in a network renting/renting step S3 after the renting/selling setting step S2, the copyrighted work is published on a renting/selling web page platform of the first network copyright license system 10. A consumer browses the renting/selling web page platform of the first network copyright license system 10, selects the copyrighted work to be read, and proceeds with a sublease. After the consumer has made the payment, the first network copyright license system 10 permits the consumer to electrically and unlimitedly read the copyrighted work during the time period of renting/selling. After the first network copyright license system 10 has received payment from the consumer, the first network copyright license system 10 electrically transfers a portion of the renting/selling fee to the bank account of the copyright owner C registered in the first network copyright license system 10 in the login step S1 according to the distribution ratio set in the renting/selling setting step S2 (the feedback S31).

A sublease setting step S4 can then be conducted. If the consumer has read the copyrighted work long before the deadline of the time period of renting/selling, the consumer can optionally proceed with sublease setting on the renting/selling web page platform of the first network copyright license system 10 during the time period of renting/selling. The sublease setting includes the sublease fee, registration of personal information and bank account information of each subleasee, and the distribution ratio of the income from the sublease of the copyrighted work. Each sublease must confirm acceptance of the distribution ratio predetermined by the first network copyright license system 10.

After the sublease setting, the first network copyright license system 10 distributes the sublease income from the copyrighted work according to the distribution ratio of the sublease. A proportional fee distributed to the first network copyright license system 10 by the sublease setting step S4 is distributed to the copyright owner C according to the distribution ratio set in the renting/selling setting step S2. The renting/selling web page platform of the first network copyright license system 10 publishes the sublease information to another consumers.

A network sublease step S5 is carried out after the sublease setting step S4. After the sublease setting step S4, the copyrighted work to be sublet and the information of the remaining time period of renting/selling (the time period of the sublease) will be published on the renting/selling web page platform of the first network copyright license system 10. Another consumer can select the copyrighted work to be sublet on the renting/selling web page platform of the first network copyright license system 10 and can proceed with a sublease. After payment by this another consumer, the first network copyright license system 10 permits this another consumer to unlimitedly read the copyrighted work during the time period of sublease. Furthermore, after payment by this another consumer, the income from the sublease is distributed according to the distribution ratio set in the sublease setting step S4 to proceed with a sublease feedback S51 and an extension feedback S52. The sublease feedback S51 includes distributing the income from the sublease to the bank account of the consumer in the sublease setting step S4 through electrical transfer. The extension feedback S52 includes distributing the income from the sublease that has been distributed to the first network copyright license system 10 based on the sublease setting in the sublease setting step S4 to the copyright owner C according to the distribution ratio set in the renting/selling setting step S2.

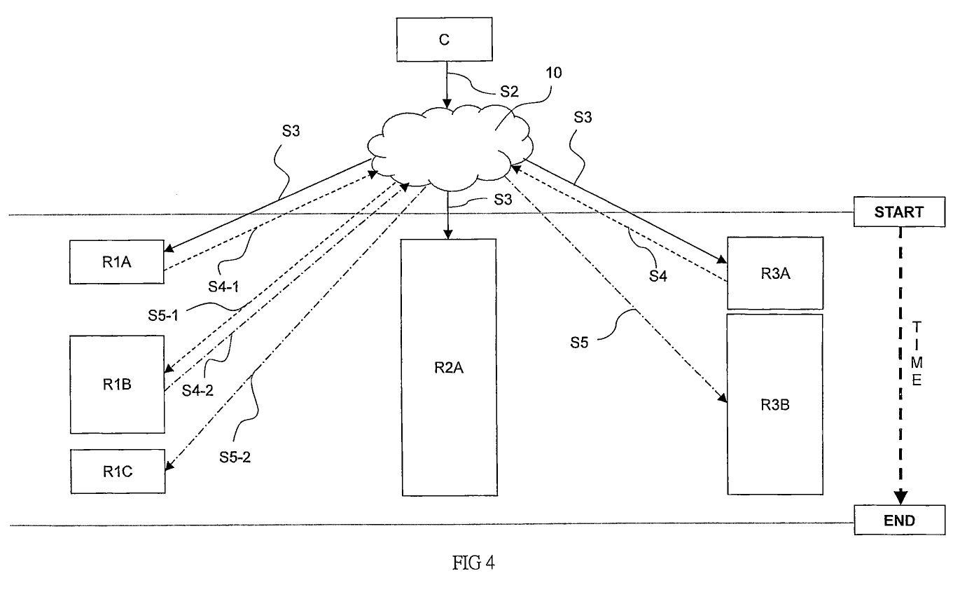

FIG. 4 is a diagrammatic view illustrating a sublease procedure of the system according to the present invention. According to the above steps S1-S5, in the method for licensing a copyrighted work over a network according to the present invention, the login steps S1 provides the copyright owner C with clear setting of the distribution ratio of the income from the copyrighted work, assuring each revenue of renting/selling. Furthermore, a platform for registering and managing the source of a copyrighted work is provided. The copyright owner C can clearly register the information of the copyrighted work through regular registration to obtain a copyright source registration meeting the regulations of the copyright law, which is a copyright network platform with a better propagating effect for independent authors.

In the steps of the method according to the present invention, by providing the sublease setting step S4 and the network sublease step S5, it can be appreciated that the copyrighted work can be rented or sold to consumers R1A, R2A, and R3A through the first network copyright license system 10. Due to different reading habits, consumer R1A has the fastest reading speed and finishes reading during the time period (TIME between START and END) in the renting/selling setting step S2. In this case, consumer R1A can proceed with a first sublease setting step S4-1 on the renting/selling web page platform of the first network copyright license system 10. During this procedure, consumer R1A can selectively set the sublease fee (which is cheaper than the renting/selling fee) according to the remaining portion of the time period (TIME) of renting/selling and can propagate to other consumers by the renting/selling web page platform of the first network copyright license system 10 in a network sublease step S5-1.

A second consumer R1B obtaining the sublease information can read the sublet copyrighted work after paying the sublease fee. If the second consumer R1B finishes reading the sublet copyrighted work before the deadline of the sublease time period, the second consumer R1B can proceed with a second sublease setting step S4-2 and then propagate to a third consumer R1C by the renting/selling web page platform of the first network copyright license system 10 in a network sublease step S5-2 in a manner similar to the above.

In a case of a slow reading condition of consumer R2A, since consumer R2A takes a longer time to read the copyrighted work, consumer R2A can decide not to sublease the copyrighted work. In the reading condition of consumer R3A, the remaining time period permits the consumer R3A to sublease the copyrighted work to a second consumer R3B. The sublease of the present invention can be set to be different in terms of the time period of the sublease and the sublease fee to provide differences in the establishment speed of the sublease or the sublease revenue, all of which are advantageous to the benefit of the copyrighted work in the renting/selling market. The method of the present invention adds the sublease setting step S4 and the network sublease step S5 into the conventional time period of renting/selling to permit the consumer to proceed with the sublease according to his or her time schedule, such that the consumption of the electric copyrighted work can have the most efficient use.

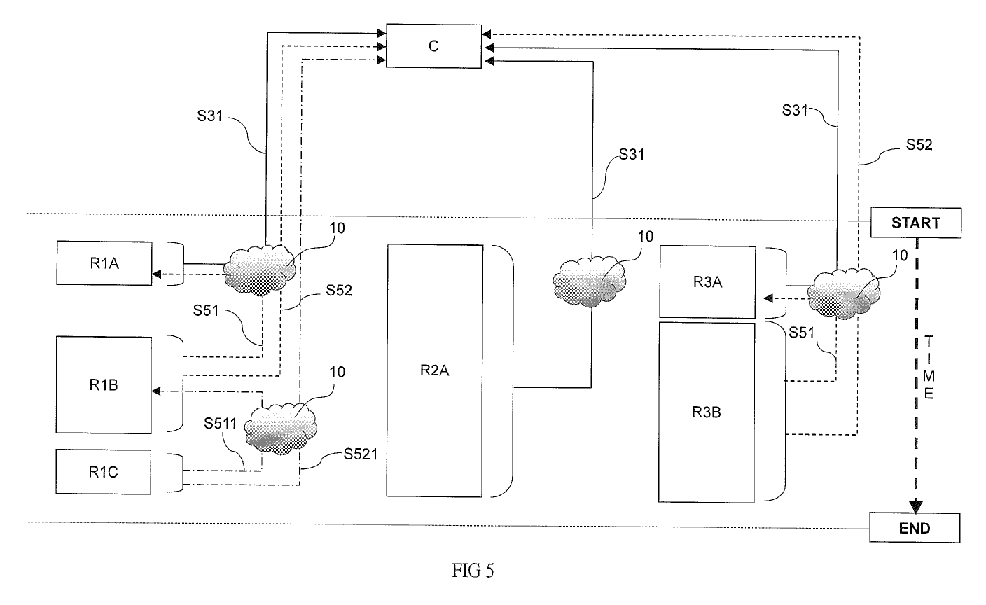

FIG. 5 is a diagrammatic view illustrating another example of the sublease setting step S4 and the network sublease step S5 of the sublease procedure of the system according to the present invention. After the renting/selling setting step S2 and during the time period (TIME between START and END), distribution can be conducted through the first network copyright license system 10 after each consumption behavior is made. Particularly, after the login step S1, each consumption expenditure can be fed back in the network renting/selling step S3 (the feedback S31) to the copyright owner C in a public distribution mechanism. Alternatively, in the network sublease step S5, the profit from extended sublease of the copyrighted work can be fed back to the copyright owner C through the sublease setting of the consumers and the extension feedback S52. The consumers are not limited by the conventional time period of consumption that leads to a waste in the remaining portion of the time period (TIME) of renting/selling. The consumers can rent/sell the remaining portion of the time period (TIME) to the second consumers in the sublease setting step S4 and the sublease feedback S51 of the network sublease step S5 to reduce the burden of the consumer. The second consumers have reduced burden for renting/selling and can read the copyrighted work at a lower renting/selling fee.

The sublease setting step S4 and the network sublease step S5 can be carried out after the network renting/selling step S3′ of the second network copyright license system 10′ to obtain the best practice and feedback of the renting/selling revenue of the copyrighted work after transregional license. In the sublease setting step S4, the consumer optionally proceeds with sublease setting on the second network copyright license system 10′ during the time period of renting/selling. The sublease setting includes the sublease fee, registration of personal information and the bank account information of each subleasee, and the distribution ratio of the income from the sublease of the copyrighted work. A proportional fee distributed to the second network copyright license system 10′ by the sublease setting step is distributed to the copyright owner C according to the distribution ratio set in the renting/selling license setting step S2′. The second network copyright license system 10′ publishes the sublease information to another consumers.

In the network sublease step, one of another consumers selects the copyrighted work to be sublet on the second network renting/selling system RS2 of the second network copyright license system 10′, and the second network renting/selling system RS2 permits the one of another consumers to unlimitedly read the copyrighted work during the time period of the sublease. The income from the sublease is distributed according to the distribution ratio set in the sublease setting step to proceed with a sublease feedback and an extension feedback. The sublease feedback includes distributing the income from the sublease to the consumer in the sublease setting step. The extension feedback includes distributing the income from the sublease that has been distributed to the second network copyright license system 10′ based on the sublease setting in the sublease setting step to the copyright owner C according to the distribution ratio set in the renting/selling license setting step S2′.

Although specific embodiments have been illustrated and described, numerous modifications and variations are still possible without departing from the scope of the invention. The scope of the invention is limited by the accompanying claims.

1. A method for licensing a copyrighted work over a network, comprising:
A Login Step: a copyright owner of a work logs in a first network copyright license system and enters information of the copyright owner into the first network copyright license system;
A Copyright Registration Step: the copyright owner uploads copyright registration information to the first network copyright license system, wherein the copyright registration information includes an identity of the copyright owner of the work, an identity of an author of the work, a completion date of the work, a type of the work, originally registered data of the work, a license approach, and license fee;
A Renting/Selling License Setting Step: a person obtains the copyright registration information uploaded by the copyright owner from the first network copyright license system, completes a renting/selling license agreement with the copyright owner through a second network copyright license system, and becomes a licensee, wherein the renting/selling license agreement includes setting of a distribution ratio of an income from renting/selling the copyrighted work, distribution information of the copyrighted work, renting/selling fee of the copyrighted work, and a time period of renting/selling the copyrighted work, and wherein the distribution ratio of the income from renting/selling the copyrighted work includes a distribution ratio of the income from renting/selling the copyrighted work between the second network copyright license system, the licensee, and the copyright owner;
A Network Renting/Selling Step: the copyrighted work is published on a second network renting/selling system of the second network copyright license system after the renting/selling license setting step, a consumer browses the second network renting/selling system and selects the copyrighted work to be read, wherein after the consumer has paid the renting/selling fee for the copyrighted work, the second network renting/selling system electrically transfers a portion of the renting/selling fee to the copyright owner according to the distribution ratio set in the renting/selling license setting step.

2. The method for licensing a copyrighted work over a network as claimed in claim 1, further comprising an optional network publication step after the copyright registration step, wherein in the network publication step:
the copyright owner proceeds with network publication of the copyrighted work through the first network copyright license system that is connected to the second network copyright license system, propagating the registered copyright information in a region covered by the second network copyright license system, such that the registered copyright information uploaded to the first network copyright license system is accessible to persons in the region covered by the second network copyright license system.

3. The method for licensing a copyrighted work over a network as claimed in claim 1, further comprising an authentication step after the copyright registration step, wherein in the authentication step, the copyright owner applies for authentication of the copyrighted work with the first network copyright license system or the second network copyright license system by an authentication system of the first network copyright license system.

4. The method for licensing a copyrighted work over a network as claimed in claim 1, wherein the first network copyright license system includes a first network renting/selling system, and wherein the first network renting/selling system performs the following steps:
A Renting/Selling Setting Step: the copyright owner proceeds with setting of renting/selling conditions of the copyrighted work, the renting/selling conditions include a distribution ratio of an income from renting/selling the copyrighted work, distribution information of the copyrighted work, renting/selling fee of the copyrighted work, and a time period of renting/selling the copyrighted work, and wherein the distribution ratio of the income from renting/selling the copyrighted work includes a distribution ratio of the income from renting/selling the copyrighted work between the first network copyright license system and the copyright owner;
A Network Renting/Renting Step: the copyrighted work is published on the first network copyright license system, a consumer browses the first network copyright license system, selects the copyrighted work to be read, and proceeds with a sublease, wherein after the first network copyright license system has received payment from the consumer, the first network copyright license system electrically transfers a portion of the renting/selling fee to the copyright owner according to the distribution ratio set in the renting/selling setting step;
A Sublease Setting Step: the consumer optionally proceeds with sublease setting on a renting/selling web page platform of the first network copyright license system during the time period of renting/selling, the sublease setting includes sublease fee, registration of personal information and bank account information of each subleasee, and a distribution ratio of an income from the sublease of the copyrighted work, wherein a proportional fee distributed to the first network copyright license system by the sublease setting step is distributed to the copyright owner according to the distribution ratio set in the renting/selling setting step, and the renting/selling web page platform of the first network copyright license system publishes the sublease information to another consumers; and
A Network Sublease Step: one of the another consumers selects the copyrighted work to be sublet on the renting/selling web page platform of the first network copyright license system, the first network copyright license system permits the one of the another consumers to unlimitedly read the copyrighted work during the time period of sublease after the one of the another consumers has paid the sublease fee, the income from the sublease is distributed according to the distribution ratio set in the sublease setting step to proceed with a sublease feedback and an extension feedback, wherein the sublease feedback includes distributing the income from the sublease to the consumer in the sublease setting step, and wherein the extension feedback includes distributing the income from the sublease that has been distributed to the first network copyright license system based on the sublease setting in the sublease setting step to the copyright owner according to the distribution ratio set in the renting/selling setting step.

5. The method for licensing a copyrighted work over a network as claimed in claim 1, wherein the second network copyright license system performs the following steps:
A Sublease Setting Step: the consumer optionally proceeds with sublease setting on the second network copyright license system during the time period of renting/selling, the sublease setting includes sublease fee, registration of personal information and bank account information of each subleasee, and a distribution ratio of an income from the sublease of the copyrighted work, wherein a proportional fee distributed to the second network copyright license system by the sublease setting step is distributed to the copyright owner according to the distribution ratio set in the renting/selling license setting step, and the second network copyright license system publishes the sublease information to another consumers; and
A Network Sublease Step: one of the another consumers selects the copyrighted work to be sublet on the second network renting/selling system of the second network copyright license system, the second network renting/selling system permits the one of the another consumers to unlimitedly read the copyrighted work during the time period of the sublease after the one of the another consumers has paid the sublease fee, the income from the sublease is distributed according to the distribution ratio set in the sublease setting step to proceed with a sublease feedback and an extension feedback, wherein the sublease feedback includes distributing the income from the sublease to the consumer in the sublease setting step, and wherein the extension feedback includes distributing the income from the sublease that has been distributed to the second network copyright license system based on the sublease setting in the sublease setting step to the copyright owner according to the distribution ratio set in the renting/selling license setting step.

6. The method for licensing a copyrighted work over a network as claimed in claim 2, wherein the first network copyright license system distributes the income from the sublease of the copyrighted work according to the sublease distribution ratio after the sublease setting step is completed.

7. The method for licensing a copyrighted work over a network as claimed in claim 2, wherein the first network copyright license system permits the consumer to electrically and unlimitedly read the copyrighted work during the time period of renting/selling after the consumer has paid in the network renting/selling step.
